(19) United States
(12) Patent Application Publication
(10) Pub. No.: US 2010/0115811 A1
(43) Pub. Date: May 13, 2010

(54) ILLUMINATED ADVERTISING INCORPORATING LIGHT EMITTING DIODES AND SIMULATING THE LUMINOUS NEON DISPLAY AS WELL AS THE METHOD OF THE MANUFACTURING OF THE ELEMENT OF ILLUMINATED ADVERTISING

(76) Inventor: Michal Koper, Lublin (PL)

Correspondence Address: Horst M. Kasper, 13 Forest Drive, Warren, NJ, 07059, US

(21) Appl. No.: 12/452,385

(22) PCT Filed: Jun. 4, 2008
(86) PCT No.: PCT/PL2008/000040

§ 371 Date: Dec. 28, 2009

(30) Foreign Application Priority Data
Jun. 27, 2007 (PL) P-382766

(51) Int. Cl. G09F 13/18; B23P 25/00

(52) U.S. Cl. 40/546; 29/458

(57) ABSTRACT

The element consists of a light rays diffusing tube (1) made of plastic, with two layers and with circular cross-section and incorporating a large number of light emitting diodes (LED) (4) incorporated individually or as the diodes strip sets connected with the power supply source by means of electrical wiring (21). In its circumferential part, the wall of the light rays diffusing tube (1) is formed in shape resembling “U” letter with its convexity (10) oriented toward the centre of the light rays diffusing tube (1), forming a groove (9) along the whole element. The diodes (4) are adhesive bonded with their light emitting side (6) to the inner surface (11) of said convexity (10) and the whole groove (9) with the light emitting diodes (4) embedded therein, is filled with a layer (12) of epoxy resin. The layer (12) covers the diodes (4) and the electric wiring (21) in the part to which the light emitting diodes (4) are connected to said electric wiring.

The element of illuminated advertising incorporating light emitting diodes (LED) and simulating the luminous neon display as well as the method of the manufacturing of the element of illuminated advertising.

A subject matter of the present invention is an element of illuminated advertising incorporating light emitting diodes (LED) and simulating the luminous neon display as well as the method of the manufacturing of the element of illuminated advertising.

The device described in WO 2006/017595 patent is known in the form of elongated light emitting bar simulating the luminous neon display. In its basic version, it is a light emitting tube formed as a bar with essentially circular cross-section. Favourably, said bar consists of the layers of material with various optical properties. The basic layer produced in course of extrusion process consists of a transparent material enabling easy light transmission. The second layer is provided as the light diffusing layer surrounding the basic layer and also produced in course of extrusion forming process. A groove incorporating a flexible strip with light emitting diodes connected to their power supply cables as the light emission source, is provided along the whole length of said bar. The light emitting bar can be provided as a rigid component or a component formed after previous heating and maintained is such shape after cooling down. According to variant solution, the elongated light emitting bar consists of a member with circular cross-section in its upper part, with flat side surfaces below its diameter and side parts bent inwards in the lower part. A channel with arcwise-shaped upper surface and with the liners made of non-transparent material provided on its sides, is situated from bottom of said member. The formed bar with upper surface similar to the arcwise-shaped upper surface of the channel in the member, is inserted between said sides. A flexible strip with light emitting diodes connected to their power supply cables, is incorporated from the bottom within the bar. Said light emitting bar is made of material or materials which may be heated up and formed into desired shape and maintain desired shape after cooling without loss of their previous properties before the heating.

The device described in PL 379722 patent application is known as the element of illuminated advertising and the method of forming of the pipe fittings made of thermoplastic material and to be used for the illuminated advertising elements simulating the luminous neon display. An element of illuminated advertising consists of the light diffusing pipe fitting made of thermoplastic material and of the light emitting diodes (LED) connected to the power source with the cables. The pipe fitting is permanently formed and characterized by the shape of cross-section similar to the circular ring. In its rear wall, the pipe fitting is provided with the openings incorporating the light emitting diodes. Said light emitting diodes are provided with chamfers on the end section of light emitting side and this side is oriented toward the pipe fitting interior. A layer of light non-transmitting adhesive is applied on the outer rear part of the pipe fitting; this layer is coating the protruding rear parts of the light emitting diodes, the electric cable laid in longitudinal direction as well as soldered joints of said cables with contact cables of the light emitting diodes. The adhesive layer is covered with a masking tape. The pipe fittings to be used for illuminated advertising elements simulating the luminous neon display are formed in prepared forming moulds, after the previous heating up to reach plastic condition. After cooling down, the formed pipe fitting is demoulded and subjected to further processing i.e. removal of burrs and the light emitting diodes are incorporated in rear wall.

The essence of the invention is the element of illuminated advertising with light emitting diodes (LED), simulating the lighting neon display consisting of an elastic or rigid light rays diffusing tube made of plastic and consisting of at least one layer with any configuration of its cross-section, but preferably with circular shape, and incorporating a large number of light emitting diodes (LED) in properly selected colours or at least one diodes strip set consisting of a flexible strip with printed circuits to enable power supply of the diodes incorporated on said strip, wherein the diodes installed individually as well as the diodes strip sets are connected with the power supply source situated out of said element by means of electrical wiring, characterized by the fact that the wall of said light rays diffusing tube is formed in the part of its circumference in the shape similar to “U” letter with convexity oriented toward the centre of the tube, forming the grove provided along the whole element. In the groove, on its inner surface located between the arms of “U” letter, the diodes are adhesive bonded with their light emitting side to said surface. The whole groove with the light emitting diodes embedded therein, is filled with a layer of epoxy resin or silicone adhesive, with said layer covering the light emitting diodes or diodes strip sets embedded in the groove and the electric wiring in the part to which the light emitting diodes or diodes strip sets are connected to said electric wiring.

The light rays diffusing tube consists of two layers, wherein each layer is made of plastic, favourably of an elastomer or soft PVC or polyethylene or polypropylene as colourless or in natural pearl colour with potential dye addition in outer layer, if needed.

The inner surface of the groove wall in the shape of “U” letter consisting of the arms connected together, is flat in its central part.

Applied light emitting diodes are provided with chamfer forming a flat surface on the end part of their light emitting side.

A top finish layer of silicone or gel coat in properly selected colour is applied onto the layer of silicone adhesive or epoxy resin.

The face openings of the light rays diffusing tube are plugged with covers.

The essence of the invention is the method of manufacturing of the illuminated advertising element consisting of the light rays diffusing tube with a groove and of the light emitting diodes or diodes strip sets characterized by the fact that the tube section to be used for this element, is flexible at ambient temperature owing to the properties of applied plastic, and its length is equal to the length of the central length of the axis of graphical element presenting said element, wherein said tube section is incorporated with the groove oriented upwards, in previously prepared forming mould. The forming mould consists of a panel, favourably made of wood or wood like material and fixed on said panel by means of screws, in the line providing desired shape, lining made of a flexible round plastic duct reinforced with spiral made of steel wire, wherein a strip with a width of (SP) constituting 0.25 up to 0.45 of the whole circumference (S) has been cut out in longitudinal direction. Then the diodes are adhesive bonded onto the inner surface of the groove on the flat chamfer on their light emitting side in spacing not less than 1.5 cm, a then said diodes or diodes strip sets are connected to electric wiring, the joints and lighting are tested for correct functioning and the groove incorporating the diodes is filled with the layer of epoxy resin or silicone adhesive. After the curing and complete drying, outer surface of the layer is coated with a top finish layer of silicone or gel coat in properly selected colour.

The tube section with increased rigidity at ambient temperature owing to applied material, is heated up in a thermal chamber or by means of hot air stream flowing through the tube until desired plasticity is achieved and the tube section is incorporated in the forming mould.

The lining is made of at least one section of the flexible round plastic duct reinforced with spiral made of steel wire, wherein a strip with a width of (SP) has been cut out in longitudinal direction and each section is fixed onto the panel by means of a screw.

An illuminated advertising element made of the plastic tube formed in the desired shape is an excellent simulation of the luminous neon display. A letter or any other graphical symbol can be easily constructed from several properly shaped elements, straight or arcwise ones. The advertising element shape performed before is fixed by means of cured epoxy resin filling the groove in the light rays diffusing tube. The layer of epoxy resin or silicone adhesive is completely invisible, because it is essentially contained only in the groove with rather small width in relation to the tube diameter and moreover said groove is situated in rear part. The diodes or diodes strip sets used for lighting, wherein the diodes are provided with the chamfered surface on their light emitting side and are adhesive bonded with this side to the groove surface by means of colourless silicone adhesive; wherein a diffused light beam is emitted by the diodes through said surface. Said light diffusion occurs mainly in course of transmission through the central wall of the groove, along its convex surface—within the central part of “U” letter. The light diffusion occurs again along the wall of the light rays diffusing tube. Therefore a glaring and uniform lighting of the light rays diffusing tube free of any excessive glaring points visible from outside is obtained.

The light rays diffusing plastic tube made of elastomer or soft PCV can be easily formed to the desired shape at ambient temperature and the tubes, particularly made of polyethylene or polypropylene, after the heating up in order to increase the plasticity. The tubes with outer layer in natural pearl colour or colourless with the addition of dye within their whole volume and applied diodes emitting light rays in specific selected colours, make it possible to achieve any demanded colour of the illuminated advertising element simulating the luminous neon display.

The illuminated advertising consisting of the elements according to the present invention with the light emitting diodes is an energy saving solution owing to significantly lower energy consumption in comparison with conventional luminous neon displays and moreover it is more durable because the service life of the light emitting diodes is higher than the service life of conventional luminous neon displays and owing to the resistance of the light emitting diodes and electric circuits to the impact of other factors, particularly weather conditions.

The method according to the present invention makes it possible to obtain the illuminated advertising elements with straight linear and curvilinear shapes in an easy and inexpensive manner. Applied forming mould consist of a panel made of wood or wood like material, suitable for multiple use, and of a lining which can be easily made of flexible round polyurethane duct wherein a strip cut out in longitudinal direction and fixed on said panel. Said cutout is used to press in a tube section to be used for the element, at ambient temperature or heated up to achieve the plastic condition. The steel wires incorporated in the polyurethane duct as its reinforcement are flexibly bent out in course of pressing in, because the diameter of the tube section is greater than the width of the cut out strip, after pressing in, the sides of said reinforced polyurethane duct constituting the lining, enclose the tube bent in the shape corresponding to the previously prepared shape of the forming mould.

The object of the invention is has been illustrated in the drawing wherein:

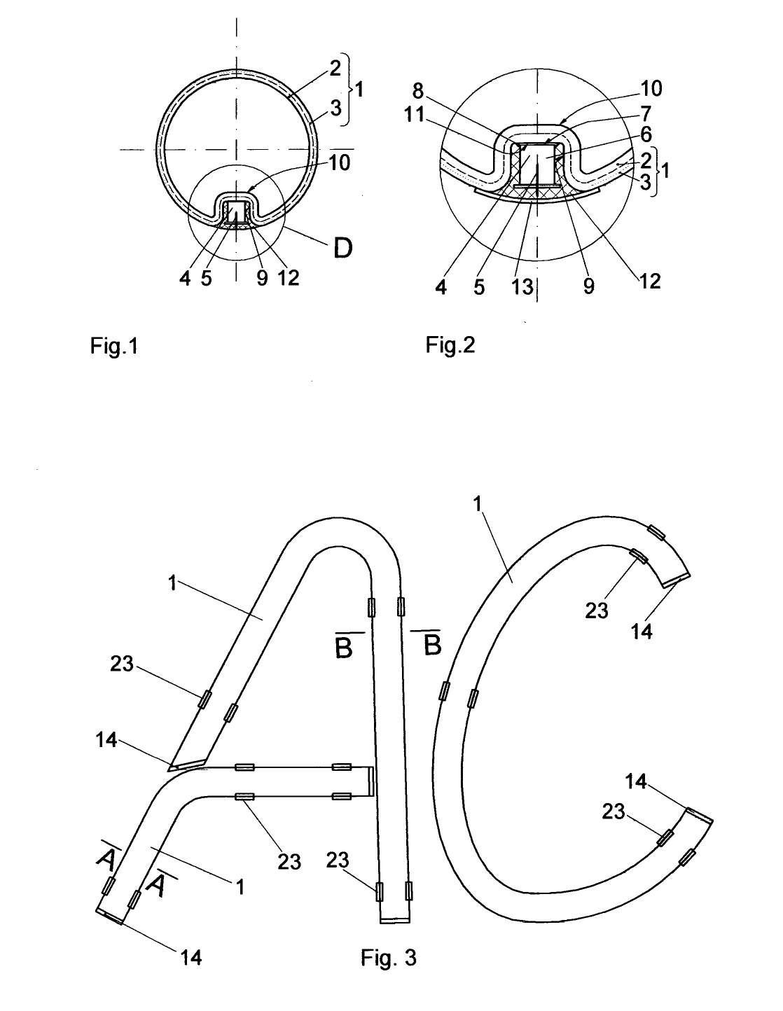

FIG. 1 represents the cross-section of the light rays diffusing tube of the element along the line A-A indicated in FIG. 3,

FIG. 2 represents, in magnification, detail D in the cross-section of the light rays diffusing tube, indicated in FIG. 1,

FIG. 3 represents the illuminated advertising AC″ consisting of three elements,

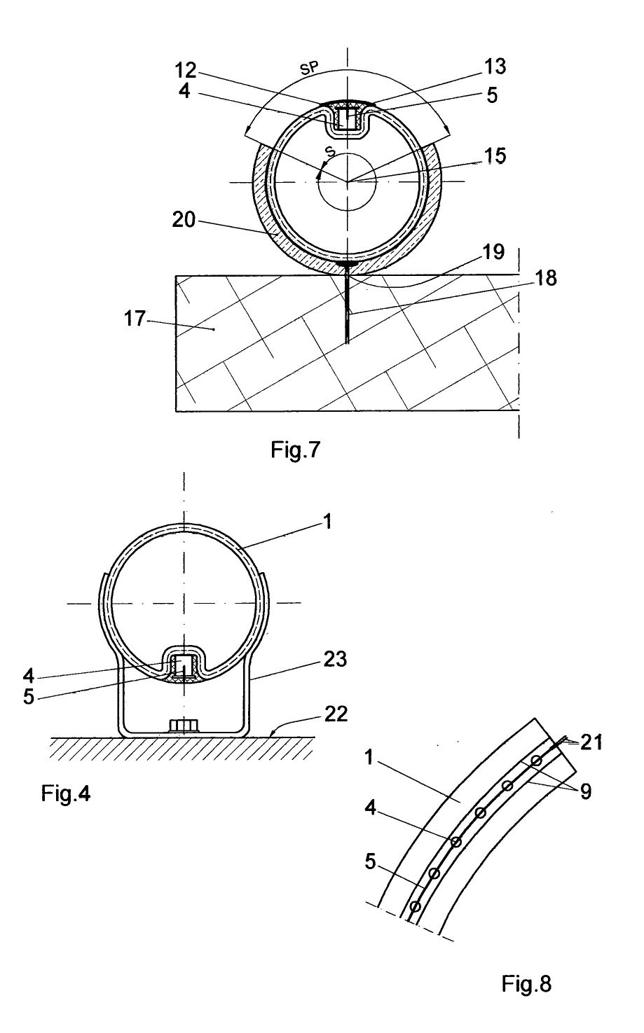

FIG. 4 represents the cross-section of the light rays diffusing tube of the element along the line B-B indicated in FIG. 3,

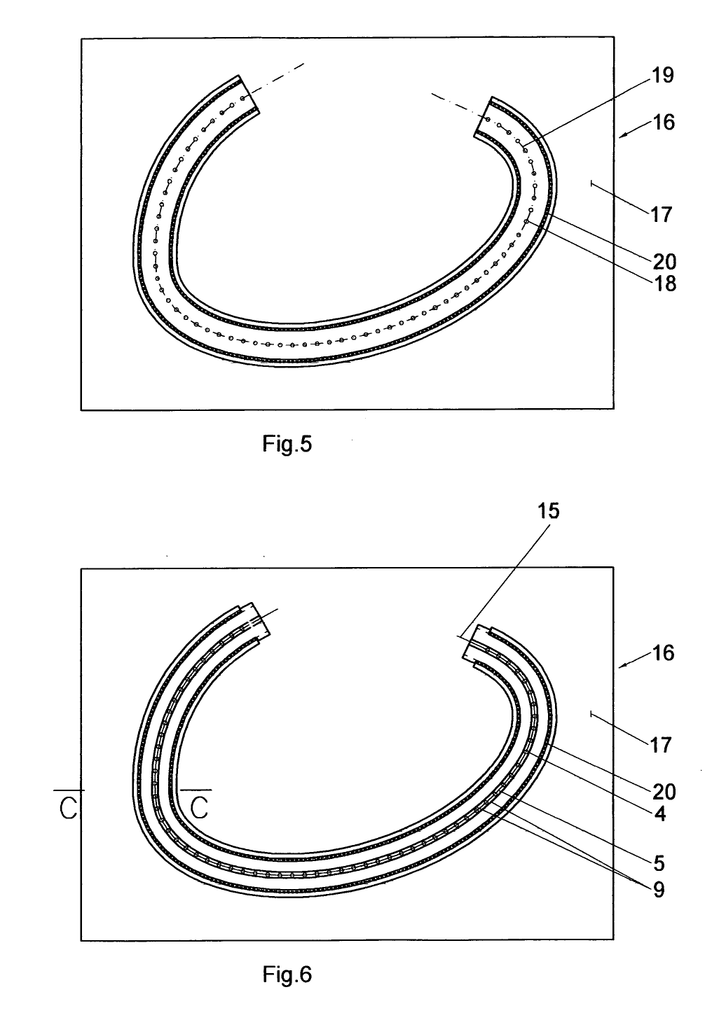

FIG. 5 represents the forming mould,

FIG. 6 represents the forming mould with the light rays diffusing tube section pressed in,

FIG. 7 represents the cross-section of the forming mould with the light rays diffusing tube pressed in along the line C-C indicated in FIG. 6,

FIG. 8 represents the view of the end of tube with the groove incorporating the diodes strip sets.

The illuminated advertising element consists of two-layer light diffusing tube 1 made of elastomer and characterized by circular shape of its cross-section with diameter of 60 mm and of diodes strip sets made of flexible strip 5 with printed circuits to enable power supply for the diodes incorporated on said strips, wherein the diodes 4 in selected colours are connected with the power supply source situated out of said element by means of electrical wiring 21. The light rays diffusing tube 1 consists of two layers, wherein inner layer 2 is colourless and the outer layer 3 contains an uniformly dissolved dye in properly selected colour. In its circumferential part, the wall of the light rays diffusing tube 1 is formed in shape resembling “U” letter with its convexity 10 oriented toward the centre of the light rays diffusing tube 1, forming a groove 9 about 11 mm wide and about 14 mm deep along the whole element. The diodes 4 incorporated on the flexible strip 5 are adhesive bonded with their chamfer 7 on their light emitting side 6 to the inner flat surface 11 on convexity 10 by means of colourless silicone adhesive 8. The whole groove 9 with incorporated diodes 4 is filled with epoxy resin layer 12 covering the diodes strip sets 5 and electrical wiring 21 incorporated in the groove 9 within the area of connection of said diode strip sets to said electrical wiring. The electrical wiring 21 coming out of the epoxy resin layer 12 are attached to the power pack situated out of the element. A top finish layer 13 of gel coat in properly selected colour is applied onto the layer of epoxy resin 12. The face openings in the light diffusing tube 1 are plugged with covers 14 with the shape adapted to the shape of the opening in the light diffusing tube 1. Each cover 14 is tightly bonded by means of silicone adhesive to the face edge of the wall of the light diffusing tube 1 along the whole circumference. The element can be fastened onto the general structure 22 of illuminated advertising for instance by means of brackets 23.

According to the method described herein, the section of the tube 1 to be used for element with the length equal to the central length of the axis 15 of the illuminated advertising element, is incorporated in its position with the groove 9 oriented upwards, in previously prepared forming mould 16 consisting of a panel 17 made of wood or wood like material and fixed on said panel by means of screws 18, in the line 19 providing desired shape, lining 20 made of a flexible round plastic duct (PU) reinforced with spiral made of steel wire. The orthogonal projections onto the plane of the panel 17 of the central panel 15 and line 19 are superimposing. Applied flexible round plastic duct (PU) reinforced with spiral made of steel wire with inner diameter of 60 mm is provided with P5PU symbol in catalogue issued by Venture Industries. In order to form a lining 20, a longitudinal strip with the width of (SP) constituting 0.35 of the whole circumference (S) has been cut out.

When the section of the tube 1 is incorporated in the forming mould 16 the diodes 4 are adhesive bonded onto the inner surface 11 of the groove 9 on the flat chamfer 7 on their light emitting side 6 in spacing of 2.5 cm, a then the diodes strip sets are connected to electric wiring 21, the joints and lighting are tested for correct functioning. Than the groove 9 incorporating the diodes strip sets is filled with the layer of epoxy resin 12 in a manner ensuring complete coating of all elements incorporated in the groove 9. After the curing of the layer of epoxy resin 12 and its complete drying, outer surface of the layer is coated with a top finish layer of gel coat 13 in properly selected colour.

According to variant embodiment of the method, when a section of the tube 1 is not sufficiently flexible, this section is heated up in a thermal chamber or by means of hot air stream flowing through the tube 1 until desired plasticity is achieved and the section is incorporated in the forming mould 16 and further operations are carried out thereafter.

The lining 20 applied in the embodiment, when the bending radius of the illuminated advertising element is smaller than the bending radius of applied PU duct to be used for the creation of a forming mould 16, said mould is constructed from short sections cut out from a flexible round polyurethane duct reinforced with a spiral made of steel wire, wherein a strip with a width of (SP) constituting 0.35 of the whole circumference (S) has been cut out in longitudinal direction and each section is fixed separately to the panel 17 by means of screw 18.

1. The element of illuminated advertising with light emitting diodes (LED), simulating the lighting neon display, consisting of an elastic or rigid light rays diffusing tube made of plastic and consisting of at least one layer with any 5 configuration of its cross-section, but preferably with circular shape, and incorporating a large number of light emitting diodes (LED) in properly selected colours or at least one diodes strip set consisting of a flexible strip with printed circuits to enable power supply of the diodes incorporated on said strip, wherein the diodes installed individually as well as the diodes strip sets are connected with the power supply source situated out of said element by means of electrical wiring, characterized in that, the wall of said light rays diffusing tube (1) is formed in the part of its circumference in the shape similar to “U” letter with convexity (10) oriented toward the centre of the tube (1), forming the grove (9) provided along the whole element, but the diodes (4) are adhesive bonded with their light emitting side (6) to the inner surface (11) of convexity (10) and the whole groove (9) with the light emitting diodes (4) incorporated therein, is filled with a layer (12) of epoxy resin or silicone adhesive, with said layer (12) covering the light emitting diodes (4) or diodes strip sets consisting of elastic strip (5) with the diodes (4) incorporated thereon and the electric wiring (21) in the part to which the light emitting diodes (4) or diodes strip sets are connected to said electric wiring.

2. The element according to claim 1, characterized in that, the said light rays diffusing tube (1) consisting of two layers with inner layer (2) and outer layer (3), wherein each layer is made of plastic, favourably of an elastomer or soft PCV or polyethylene or polypropylene as a colourless layer or in natural pearl colour with potential dye addition in outer layer (3).

3. The element according to claim 1, characterized in that, the inner surface (11) of the convexity (10) in the central part, is flat.

4. The element according to claim 1 characterized in that, the light emitting diodes (4) arc provided with the chamfer (7) on the end part of their light emitting side (6).

5. The element according to claim 1, characterized in that, a top finish layer (13) of silicone or gel coat in properly selected colour is applied onto the layer (12) of silicone adhesive or epoxy resin.

6. The element according to claim 1, characterized in that, the face openings of the light rays diffusing tube (1) are plugged with covers (14).

7. The method of manufacturing of the illuminated advertising element consisting of the light rays diffusing tube with a groove and of the light emitting diodes or diodes strip sets, characterized in that, the section of tube (1) to be used for this element, is flexible at ambient temperature owing to the properties of applied plastic, and its length is equal to the length of the central length of the axis (IS) of the advertising element, wherein said tube section is incorporated with the groove (9) oriented upwards in previously prepared forming mould (16) consisting of panel (17), favourably made of wood or wood like material and fixed on said panel by means of screws (18) in the line (19) providing desired shape, lining (20) made of a flexible round plastic duct reinforced with spiral made of steel wire, wherein a strip with a width of (SP) constituting 0.25 up to 0.45 of the whole circumference (S) has been cut out in longitudinal direction, wherein the diodes (4) are adhesive bonded onto the inner surface (11) of the groove (9) on the flat chamfer (7) on their light emitting side (6) in spacing not less than 1.5 cm, a then said diodes (4) or diodes strip sets (5) are connected to electric wiring (21), the joints and lighting are tested for correct functioning and the groove (9) with the diodes (4) incorporated individually or on the elastic strip (5) as a diodes strip set is filled with the layer (12) of epoxy resin or silicone adhesive and after the drying, outer surface of the layer is coated with a top finish layer (13) of silicone or gel coat in properly selected colour.

8. The method of manufacturing according to claim 7, characterized in that,
the section of tube (1) with increased rigidity at ambient temperature owing to applied material, is heated up in a thermal chamber or by means of hot air stream flowing through the tube (1) until desired plasticity is achieved and the tube section is incorporated in the forming mould (16) thereafter.

9. The method of manufacturing according to claim 7, characterized in that, the lining (20) consists of at least one section of a flexible round plastic duct reinforced with spiral made of steel wire, wherein a strip with a width of (SP) has been cut out in longitudinal direction and each section is fixed to the panel (17) separately by means of screws (18).
